(19) United States
(12) Patent Application Publication
(10) Pub. No.: US 2026/0147407 A1
(43) Pub. Date: May 28, 2026

(54) HEAD-WORN DEVICE CONFIGURED FOR HEAD-GESTURE DETECTION

(71) Applicant: GOOGLE LLC, Mountain View, CA (US)

(72) Inventor: Qiyue Zhang, Santa Clara, CA (US)

(21) Appl. No.: 19/398,300

(22) Filed: Nov. 24, 2025

Related U.S. Application Data
(60) Provisional application No. 63/725,396, filed on Nov. 26, 2024.

(51) Int. Cl. G06F 3/01; G02B 27/00; G02B 27/01

(52) U.S. Cl. CPC G06F 3/012; G02B 27/0093; G02B 27/017; G02B 2027/0178

(57) ABSTRACT

A system and method is disclosed for detecting and verifying head gestures using an inertial measurement unit (IMU) that includes a gyroscope and an accelerometer. The method involves activating the IMU for a specified period, analyzing the gyroscope's output to detect a head gesture based on a first set of criteria, and subsequently analyzing the IMU's second output to verify the detected head gesture against a second set of criteria. This innovative approach leverages the capabilities of the IMU to accurately capture and interpret head movements, offering a reliable and efficient solution for gesture recognition applications

### CROSS REFERENCE TO RELATED APPLICATION

This application claims the benefit to U.S. Provisional Application No. 63/725,396, filed November 26, 2024, the disclosure of which is incorporated herein by reference in its entirety.

### BACKGROUND

Head-worn devices, which may be implemented as glasses, visors, or head-sets, can be configured to generate augmented reality (i.e., AR), virtual reality (i.e., VR), or extended reality (i.e., XR) environments for a user. Generating these environments can include rendering virtual objects, which can be displayed relative to the position and orientation (i.e., pose) of the user's head. The virtual objects displayed on the head-worn device may change their rendered position and/or orientation in response to a movement of the user’s head. Accordingly, these head-worn devices may include motion sensors configured to measure movements of the user’s head.

The motion sensors can be integrated into a device known as an inertial measurement unit (i.e., IMU). In head-worn devices, the IMU includes three gyroscopes configured to measure angular rates of motion (i.e., rotations) about three directions (i.e., x, y, z). The IMU may further include three accelerometers configured to measure forces of motion (i.e., accelerations) in the three directions. The three rotations and the three accelerations may be used to measure the motion with six degrees of freedom (i.e., 6-DoF). In some cases, only the three rotations are used to measure the motion with three degrees of freedom (i.e., 3-DoF). Because the motion measurements are captured for rendering the virtual environment, they may be available for other applications without requiring any additional power.

### SUMMARY

In some aspects, the techniques described herein relate to a method including: activating an inertial measurement unit for a period, the inertial measurement unit including a gyroscope and an accelerometer; analyzing a first output of the gyroscope; comparing the first output of to a first set of criteria to detect a head gesture; analyzing a second output of the inertial measurement unit; and comparing the second output to a second set of criteria to verify the head gesture.

In some aspects, the techniques described herein relate to a method including: receiving a response-request signal from an application running on a head-worn device, the head-worn device including a plurality of gyroscopes and a plurality of accelerometers; and activating a process for a period initiated by the response-request signal, the process including: analyzing, using logic, rotation measurements collected by the plurality of gyroscopes during the period to detect a head gesture; analyzing, using logic, acceleration measurements collected by the plurality of accelerometers during the period to assign a confidence to the head gesture; and transmitting a response-reply signal to the application based on the head gesture and the confidence.

In some aspects, the techniques described herein relate to a head-worn device including: a plurality of gyroscopes configured to measure an X-axis rotation of the head-worn device, a Y-axis rotation of the head-worn device, and a Z-axis rotation of the head-worn device; a plurality of accelerometers configured to measure an X-axis acceleration of the head-worn device, a Y-axis acceleration of the head-worn device, and a Z-axis acceleration of the head-worn device; and a processor configured by software instructions activated by a response request signal received from an application running on the head-worn device to: analyze, using logic, rotation measurements collected by the plurality of gyroscopes during a period to detect a head gesture; analyze, using logic, acceleration measurements collected by the plurality of accelerometers during the period to assign a confidence to the head gesture; and transmit a response-reply signal to the application in response to expiration of the period based on the head gesture and the confidence.

In some aspects, the techniques described herein relate to a non-transitory computer-readable medium including software instructions stored thereon that when executed by a processor of a head-worn device cause the head-worn device to: receive a response-request signal from an application running on the head-worn device, the head-worn device including a plurality of gyroscopes and a plurality of accelerometers; and activate a process for a period initiated by the response-request signal, the process including: analyzing, using logic, rotation measurements collected by the plurality of gyroscopes during the period to detect a head gesture; analyzing, using logic, acceleration measurements collected by the plurality of accelerometers during the period to assign a confidence to the head gesture; and transmitting a response-reply signal to the application based on the head gesture and the confidence.

The foregoing illustrative summary, as well as other example objectives and/or advantages of the disclosure, and the manner in which the same are accomplished, are further explained within the following detailed description and its accompanying drawings.

### BRIEF DESCRIPTION OF THE DRAWINGS

FIG. 1 illustrates a head-worn device according to a possible implementation of the present disclosure.

FIG. 2A illustrates a head shake gesture of a user wearing a head-worn device according to a possible implementation of the present disclosure.

FIG. 2B illustrates a head nod gesture of a user wearing a head-worn device according to a possible implementation of the present disclosure.

FIG. 3 illustrates an inertial measurement unit according to a possible implementation of the present disclosure.

FIG. 4 illustrates a system for gesture interaction with an application according to a possible implementation of the present disclosure.

FIG. 5 is a block diagram of a gesture detector according to a possible implementation of the present disclosure.

FIG. 6A illustrates rotation measurements corresponding to a head nod according to a possible implementation of the present disclosure.

FIG. 6B illustrates acceleration measurements corresponding to a head nod according to a possible implementation of the present disclosure.

FIG. 7A illustrates nod rotation logic according to a possible implementation of the present disclosure.

FIG. 7B illustrates nod acceleration logic according to a possible implementation of the present disclosure.

FIG. 8A illustrates rotation measurements corresponding to a head shake according to a possible implementation of the present disclosure.

FIG. 8B illustrates acceleration measurements corresponding to a head shake according to a possible implementation of the present disclosure.

FIG. 9A illustrates shake rotation logic according to a possible implementation of the present disclosure.

FIG. 9B illustrates shake acceleration logic according to a possible implementation of the present disclosure.

FIG. 10 is a flowchart of a method for interacting with an application based on a head gesture according to a possible implementation of the present disclosure.

FIG. 11A illustrates a head tilt gesture of a user wearing a head-worn device according to a possible implementation of the present disclosure.

FIG. 11B illustrates tilt rotation logic according to a possible implementation of the present disclosure.

FIG. 11C illustrates tilt acceleration logic according to a possible implementation of the present disclosure.

The components in the drawings are not necessarily to scale relative to each other. Like reference numerals designate corresponding parts throughout the several views.

### DETAILED DESCRIPTION

Interacting with head-worn devices (e.g., AR glasses, AR visor, XR glasses, smart glasses, etc.), using touches, swipes, or learned hand gestures can be relatively awkward, making hands-free gesture detection desirable. Hands-free gesture detection, however, often relies on computationally intense machine learning models, which can reduce the battery life of the device. The disclosed systems and methods address this technical problem with a rules-based (i.e., logic-based) hands-free gesture detection approach, which can operate in a more power-efficient way.

The rules-based approach can analyze the data from motion sensors for patterns based on simple logic (i.e., rules) instead of machine learning models. Additionally, because the motion sensors (e.g., gyroscopes, accelerometers) may already be active on the device, the rules-based analysis does not require any added resources to capture motion data. Further, the rules-based analysis may be activated for only finite periods at a time, which can further reduce the power consumed. As a result, the disclosed rules-based processing of sensor data may have the technical effect of implementing reliable, low-latency gesture input on the head-worn device while consuming significantly less power and processing resources compared to conventional machine-learning based methods.

A head gesture is a convenient and intuitive type of hands-free gesture, which can be used to indicate a response (e.g., YES, NO). For example, consider a head-worn device displaying a message posing a question (e.g., "Read this message?"). Instead of requiring a user to locate and interact with a button or to perform some known hand gesture, a user can simply nod their head to reply "yes" or shake their head to reply "no" in response to the question.

Head-gesture interaction can be complicated for a few reasons. For example, the motion sensors used to sense the head-gestures can be very sensitive so that movements unrelated to a head gesture can mimic or mask a head nod (i.e., nod) or head shake (i.e., shake). Additionally, the motion sensors used to sense the head-gestures may have systematic errors (e.g., offset), which require calibration before determining an amount of a detected movement.

The disclosed approach has a few advantages besides power savings. False positive detections and/or false negative detections due to unrelated movements can be reduced because the rules are limited to looking for nods and shakes during a finite period. Further, because the rules (i.e., logic) look for changes in a user’s head pose relative to a threshold (or thresholds), the rules-based approach can be more immune to subtle variations in the motion data (e.g., due to temperature), which could reduce the accuracy in an absolute measurement of the user’s head pose. Finally, the rules can assign a confidence level to a detection by comparing the measurements made by different types of motion sensors, which can provide added insight about the head gesture to an application which may change its response based on the confidence. For example, a confidence score (e.g., LOW, HIGH) can allow a head-worn device (i.e., computing device) to reliably distinguish intentional gestures from inadvertent user movements. Accordingly, the confidence score can improve the head-worn device’s operation by reducing erroneous inputs and preventing the wasteful execution of subsequent processes that would otherwise be triggered by false positives.

Head-worn devices, such as smart glasses, AR glasses, AR visors, or virtual reality (VR) headsets, are computing systems designed to be worn on a user's head. These devices are configured to generate immersive digital experiences, including augmented reality (AR), where digital information is overlaid onto the real world, and VR, which places the user in a completely virtual environment.

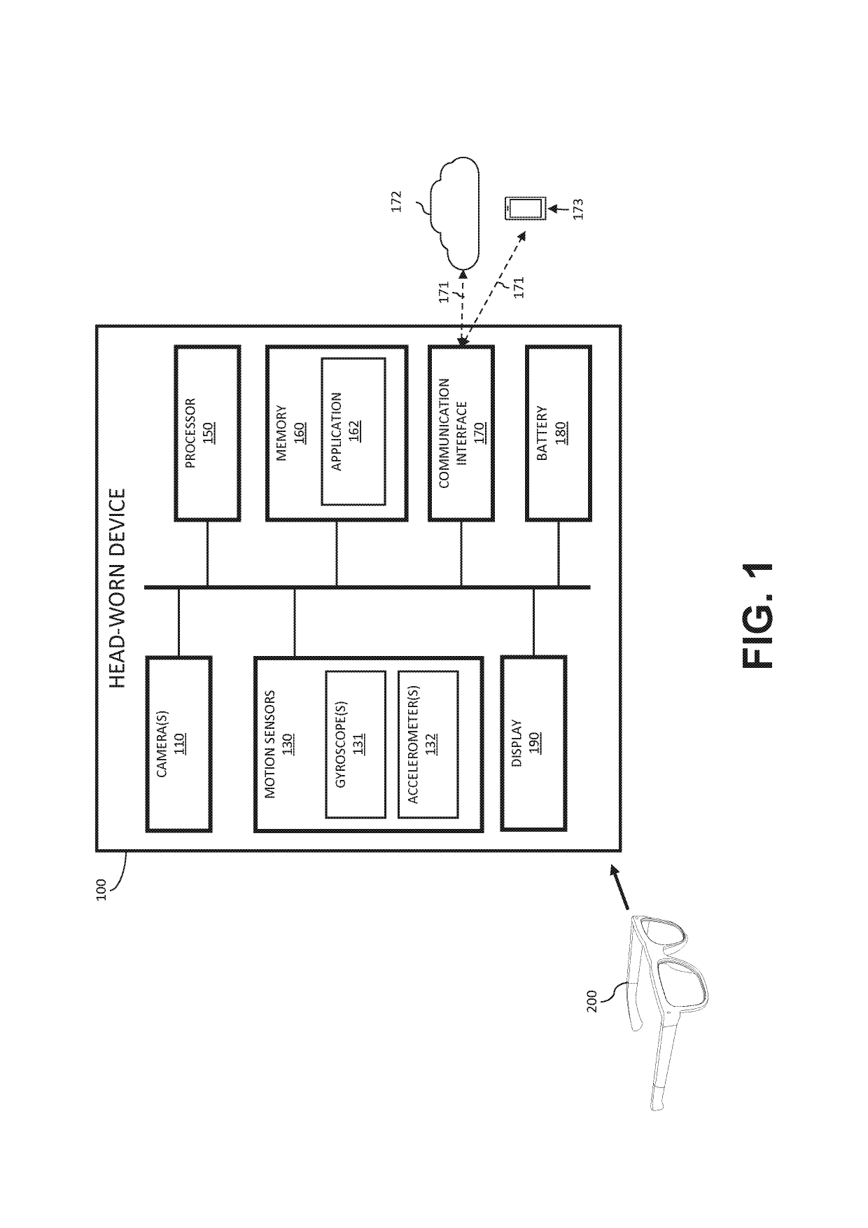

FIG. 1 is a dual-part illustration of a head-worn device that includes a system block diagram of a possible hardware architecture of the head-worn device 100, and a perspective view of a possible form factor (i.e., AR glasses 200) of the head-worn device. As shown, the hardware architecture of the head-worn device 100 can include a processor 150 (or processors), a memory 160 (e.g., non-transitory computer-readable medium), motion sensors 130, a camera 110 (or cameras), a display 190 (or displays), a communication interface 170, and a battery 180.

The processor 150 may be configured to perform the computational tasks required to create and present an environment (e.g., AR environment, VR environment, extended reality (XR) environment) to a user. In doing so, the processor 150 may collect and use data from the camera 110 and motion sensors 130 to render virtual content, which can be displayed to a user on the display 190.

The processor 150 is in communication with the memory 160. Software instructions stored on the memory 160 may configure the processor 150 to perform functions related to an application 162. For example, the application 162 may query a user for a response. This may include the application 162 generating a response-request signal (e.g., yes-no request signal) that can trigger the processor 150 to activate a process on the head-worn device, which includes determining a reply. The reply may be implemented as a response-reply signal (e.g., yes-no-reply signal), which can be received by the application 162 so that a branch process corresponding to the reply can be executed.

In a possible implementation, the processor 150 is an application processor (AP), or a specialized system-on-a-chip (SoC), that integrates various processing units. The processing units can include a central processing unit (CPU) configured to manage general-purpose computing tasks, such as running the operating system, managing applications, and controlling other components. The processing units can further include a graphics processing unit (GPU) configured for rendering graphics, such as 3D virtual objects, and overlaying them smoothly onto the real-world view. The rendering can include tasks like texture mapping, shading, and lighting. The processing units can further include a digital signal processor (DSP) configured for high-speed signal processing. the high-speed signal processing can include tasks like audio processing or processing data from the motion sensors.

The motion sensors 130 Motion sensors the head-worn device 100 can be configured to measure over time (i.e., track) the user's movement and orientation in the real world. One of their primary functions is to provide the data necessary for real-time tracking of the environment to ensure that virtual objects remain stable and correctly positioned on the display 190 relative to the user's changing perspective. This helps create a convincing and immersive experience where digital content appears to be a part of the real environment.

The motion sensors 130 can be implemented as an inertial measurement unit (IMU), which combines multiple sensors into a single device. The multiple sensors can include one or more accelerometers 132 configured to measure linear acceleration and gravity. For example, an IMU may include three accelerometers, each aligned with one direction (X, Y, Z) of a coordinate system. The multiple sensors can include one or more gyroscopes 131 configured to measure rotational motion. For example, the IMU may include three gyroscopes, each aligned with one direction (X, Y, Z) of the coordinate system.

The display 190 of the head-worn device 100 can be a see-through optical system that overlays computer generated images (i.e., virtual objects) onto the user’s view of the real word (i.e., heads-up display). The display 190 can include a small high-resolution display panel (e.g., screen) that generates the image. In a possible implementation, the display panel includes micro light emitting diodes (i.e., micro-LEDs) operating as pixels. The display 190 may also include an optical engine configured to route and project the light from the display panel to the user’s eye (or eyes).

The battery 180 of the head-worn device 100 can balance high energy density with an extremely small form factor and light weight. For example, AR glasses must have a battery that can be integrated into a slim, lightweight frame without adding noticeable bulk or heat. This may be a challenge, because AR glasses can require constant power for their display, processor, sensors, and wireless connectivity. As a result, there may be little power to spare for gesture detection.

The communication interface 170 of the head-worn device 100 is configured to send and receive data over a wireless communication channel 171 (e.g., Bluetooth^{TM}) to connect the head-worn device 100 to another device 173 (e.g., smart phone, smart watch, etc.) or a network 172 (e.g., the cloud).

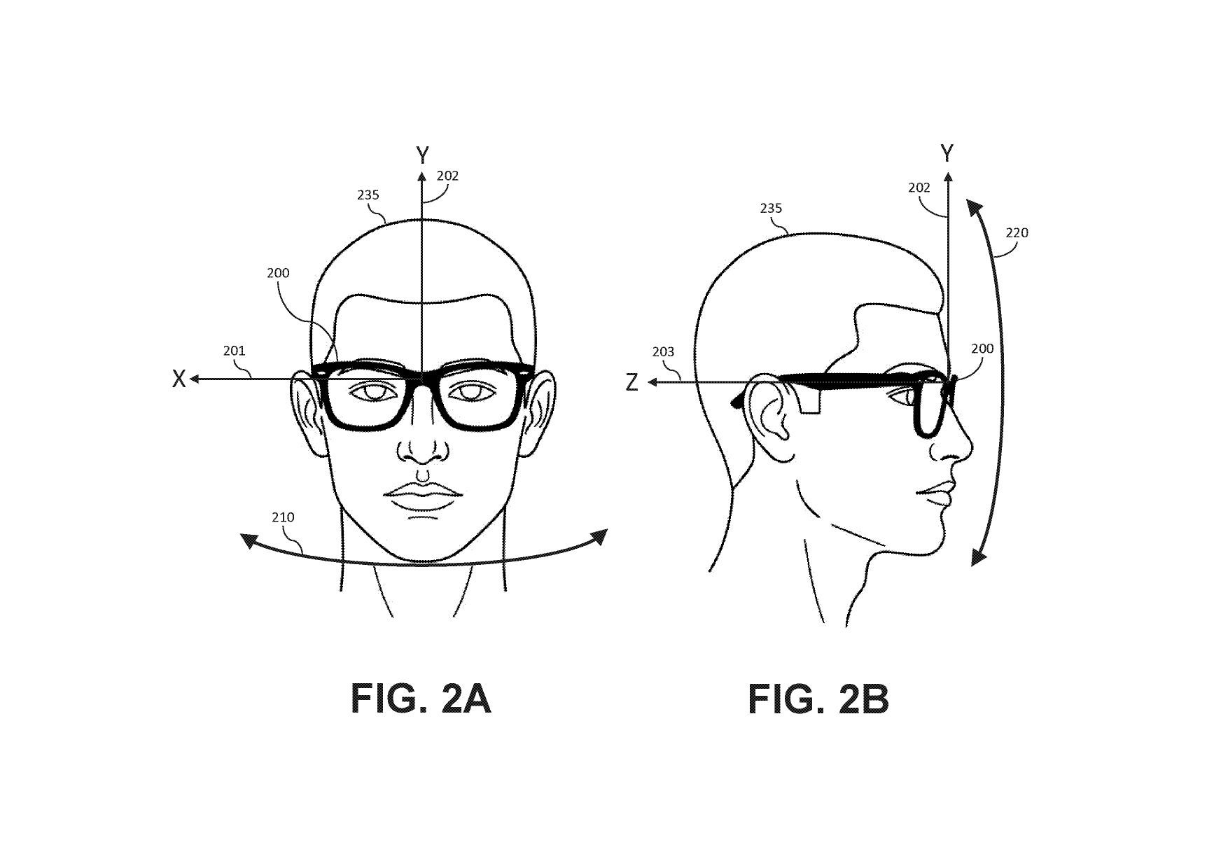

FIGS. 2A and 2B illustrate different head gestures of a user wearing a head-worn device relative to a coordinate system of the head-worn device according to a possible implementation of the present disclosure. FIG. 2A illustrates a head shake 210 normally associated with a NO response, while FIG. 2B illustrates a head nod 220 normally associated with a YES response. Head gestures can be described based on a coordinate system aligned with the AR glasses 200 and the head 235 of the user. In a possible implementation, the coordinate system includes an X-axis 201, a Y-axis 202, and a Z-axis 203. This coordinate system aligns with the world coordinate system, which is based on gravity, when the user is in a standard position. In the standard position, the top of the head 235 faces up (e.g., towards the sky in a direction perpendicular to the ground). In the standard position, the negative Y direction (-Y) is aligned with the force of gravity (G).

FIG. 2A is a front view of a user wearing a head-worn device according to a possible implementation of the present disclosure. As shown, the X-axis 201 may have a positive X direction (+X) towards the user’s right ear and a negative X direction (-X) towards the user’s left ear. As shown, a Y-axis 202 may have a positive Y direction (+Y) towards the top of the head 235 and a negative Y direction towards the chin (-Y). A head shake 210 may include the user rotating their head 235 around the Y-axis 202 so that their face (e.g., chin) moves alternatively right (i.e., +X direction) and left (i.e., -X direction).

FIG. 2B is a side view of a user wearing a head-worn device according to a possible implementation of the present disclosure. As shown, the Z-axis 203 may have a positive Z direction (+Z) towards the back of the head 235 and a negative Z direction (-Z) towards the user’s field of view. As shown, the Y-axis 202 may have the positive Y direction (+Y) towards the top of the head 235 and a negative Y direction towards the chin (-Y). A head nod 220 may include the user rotating their head 235 around the X-axis 201 so that their face (e.g., chin) moves alternatively up (i.e., +Y direction) and down (i.e., -Y direction).

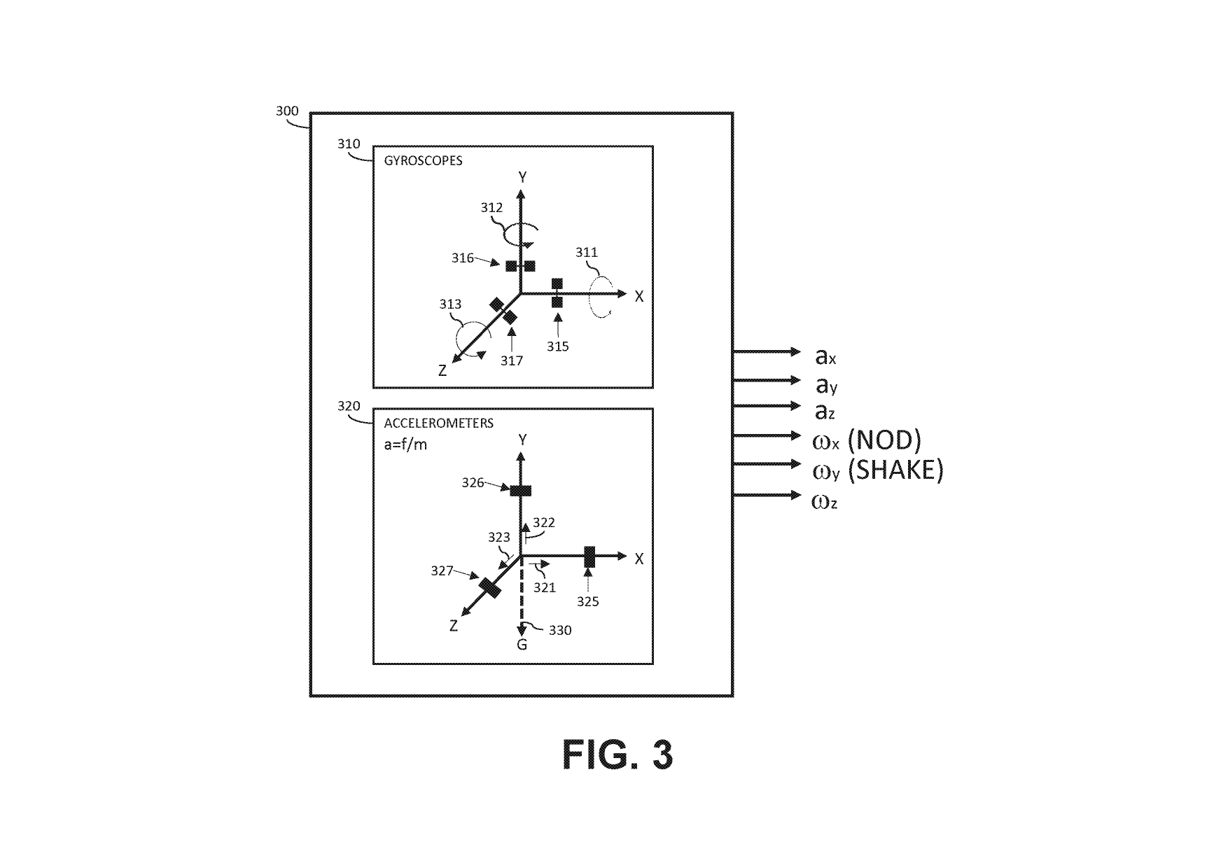

FIG. 3 is an inertial measurement unit (IMU 300) according to a possible implementation of the present disclosure. The IMU 300 is a small sensor package used to determine the orientation and motion of the AR glasses 200 in three-dimensional (3D) space. The sensors may be configured to measure the specific forces, angular rates, and sometimes magnetic fields in directions that are approximately aligned with the axes of the coordinate system illustrated in FIGS. 2A and 2B. In other words, the coordinate system of the IMU may be aligned with a coordinate system of the head-mounted device, which when worn by a user can be aligned with the head of the user.

As shown, the IMU 300 can include a gyroscope module 310 including a plurality of gyroscopes. Each gyroscope is configured to measure the rate of rotation in radians/second (i.e., rad/sec) around an axis of the coordinate system. The rotations can be used to determine how the IMU is spinning or turning in 3D space, which can be used to track an orientation of the head 235.

As shown, the gyroscope module 310 may have three outputs, with each output representing a rotation (i.e., yaw, pitch, roll) about an axis of the coordinate system. As shown, a first output may be an X-axis rotation 311 (i.e., ω_{X} ); a second output may be a Y-axis rotation 312 (i.e., ω_{Y}); and a third output may be a Z-axis rotation 313 (i.e., ω_{Z}).

The IMU may be positioned and aligned within the AR glasses 200 to measure movements of the head 235. For example, the head shake 210 may be measured primarily by the Y-axis gyroscope 316 and the head nod 220 may be measured primarily by the X-axis gyroscope 315 of the IMU 300. Additionally, a head tilt may be measured primarily by the Z-axis gyroscope 317.

Each gyroscope may be implemented as a micro-electro-mechanical system (MEMS) that has a vibrating proof mass. The proof mass can be a tuning fork that is driven at a frequency along one axis. When the IMU rotates, the Coriolis effect causes the vibrating proof mass to shift. This shift (i.e., displacement) can be measured and converted to the rate of rotation.

As shown, the IMU 300 can include an accelerometer module 320 including a plurality of accelerometers. Each accelerometer is configured to measure the acceleration in meters per second squared (i.e., m/sec²)) along an axis of the coordinate system.

As shown, the accelerometer module 320 may have three outputs, with each output representing an acceleration along an axis of the coordinate system. As shown, a first output may be an X-axis acceleration 321 (i.e., a_{X} ) measured by an x-axis accelerometer 325; a second output may be a Y-axis acceleration 322 (i.e., a_{Y}) measured by a y-axis accelerometer 326; and a third output may be a Z-axis acceleration 323 (i.e., a_{Z}) measured by a z-axis accelerometer 327.

The outputs may represent a change in the IMU’s velocity when the IMU is moved (i.e., linear acceleration). The outputs may also represent the orientation of the IMU when the IMU is stationary. For example, the orientation may be determined based on which axis (or axes) is experiencing the force of gravity (i.e., 9.8 m/sec²). As shown, the force of gravity 330 (G) is in the -Y direction when the head 235 of the user is in the standard position (see FIGS. 2A, 2B).

The effect of gravity may be observed as a bias on one of more of the outputs of the accelerometer. For example, when the head is in the standard position a bias on -9.8 m/sec² will appear as a bias (i.e., offset) on any signal created by a movement in the Y-direction. Accordingly, analyzing the acceleration measurements from the IMU may include removing the bias from an acceleration measurement so that only the head movements are considered.

Each accelerometer may be implemented as a MEMS with a movable mass (i.e. proof mass) suspended by springs. When an external force, like acceleration or gravity, acts on the IMU, the proof mass experiences an inertial force. This force causes the proof mass to be displaced. The displacement can be measured and converted to an acceleration.

A rotation can exert a centripetal force that can be measured by an accelerometer. Centripetal force is the force that acts on the proof mass to keep it moving along the curved path of the rotation. As an accelerometer is rotated the spring may experience tension from the centripetal force which acts to keep the proof mass moving along the curved path. For example, the head shake 210 may cause centripetal forces in the X-direction and the Z-direction (i.e., in the XZ plane), while a head nod 220 may cause centripetal forces in the Y-direction and the Z-direction (i.e., in the YZ plane). Additionally, a head tilt may cause centripetal forces in the X-direction and the Y-direction (i.e., in the XY plane).

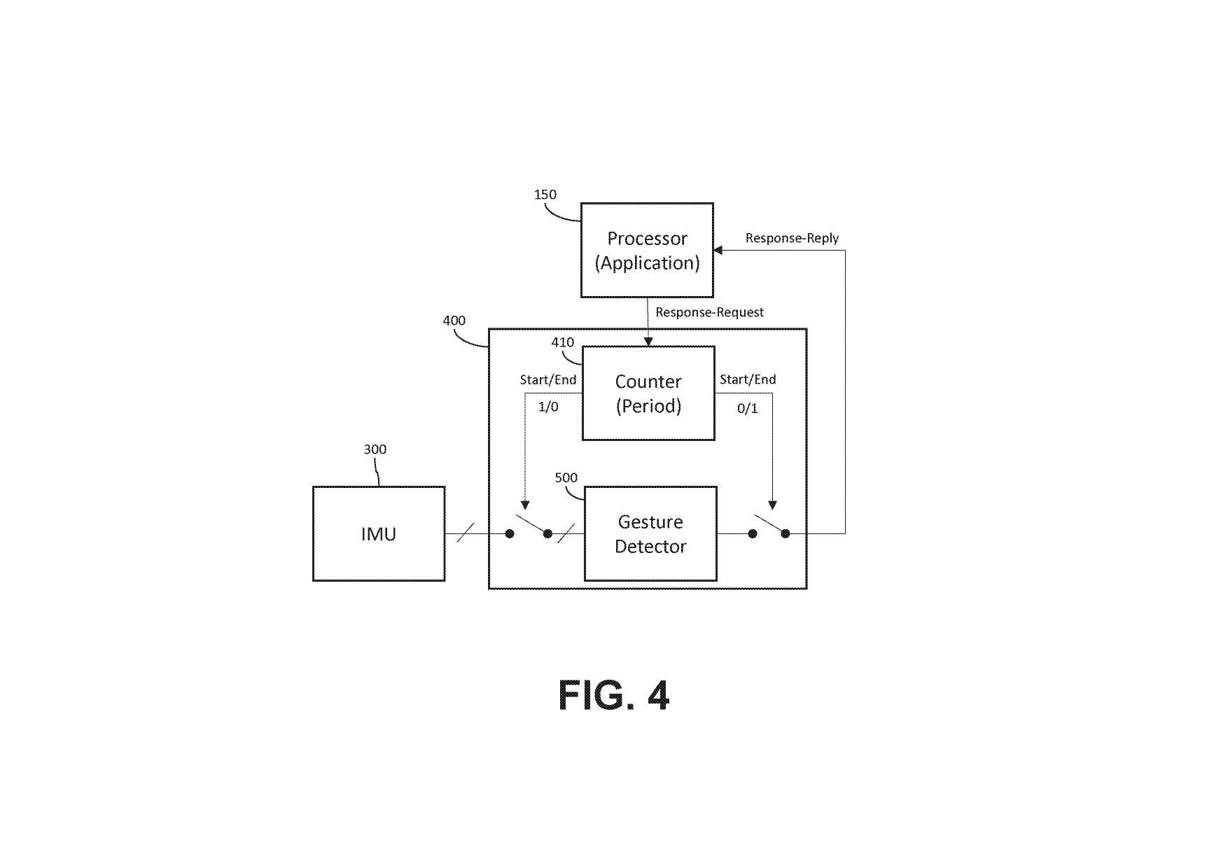

FIG. 4 illustrates a system for gesture interaction with an application according to a possible implementation of the present disclosure. As shown, a processor 150 configured by an application can issue (i.e., transmit) a response request signal to the system 400. The response-request signal can indicate that the application has reached a point where it seeks a "yes" or "no" answer from the user. In a possible implementation, the response-request signal may be a trigger signal (e.g., binary pulse) corresponding in time to a query presented to the user (e.g., on the display).

The response-request signal activates the system 400 to search for a response from the user within a period and to transmit a response-reply signal to the processor 150 after the period has concluded. The response-reply signal indicates the answer to the query (i.e., the reply from the user). For example, the response-reply signal can indicate a yes answer (i.e. YES), a no answer (i.e., NO), or a no-reply answer.

The system 400 can be implemented in hardware, software, or some combination thereof. In a possible implementation, the system 400 includes a timer that controls (i.e., starts and stops) the period. For example, the timer may be a counter 410 that starts counting upon receipt of the response-request signal and continues to count until it reaches a value representing a time. The time may be selected based on an average amount of time a person requires to perform a head nod (to indicate YES) or a head shake (to indicate NO). For example, the counter may count for between 1 and 3 seconds before stopping (i.e., the period is between 1 and 3 seconds).

The system 400 further includes a gesture detector 500 that is configured to analyze the motion measurements collected by the IMU during the period to detect a head gesture. In a first possible configuration, the analysis includes analyzing rotation measurements collected by a plurality of gyroscopes during the period. In a second possible configuration, the analysis includes analyzing acceleration measurements collected by a plurality of accelerometers during the period. In a third possible configuration, the analysis includes analyzing both rotation measurements collected by the plurality of gyroscopes and acceleration measurements collected by the plurality of accelerometers during the period. The configuration may be selectable based on a condition of the head-worn device. For example, a low-power condition of the head-worn device may trigger the gesture detector 500 to only consider acceleration measurements in the analysis because in the low-power condition, the gyroscopes may be disabled to conserve power.

The gesture detector 500 may be configured to receive data from the motion sensors during the period. For example, at the start of the period, the input of the gesture detector 500 may be coupled to the IMU 300 and at the end of the period the input of the gesture detector 500 may be decoupled from the IMU 300. Additionally, at the start of the period, the output of the gesture detector 500 may be decoupled from the IMU 300 and at the end of the period the output of the gesture detector 500 may be coupled to the IMU 300.

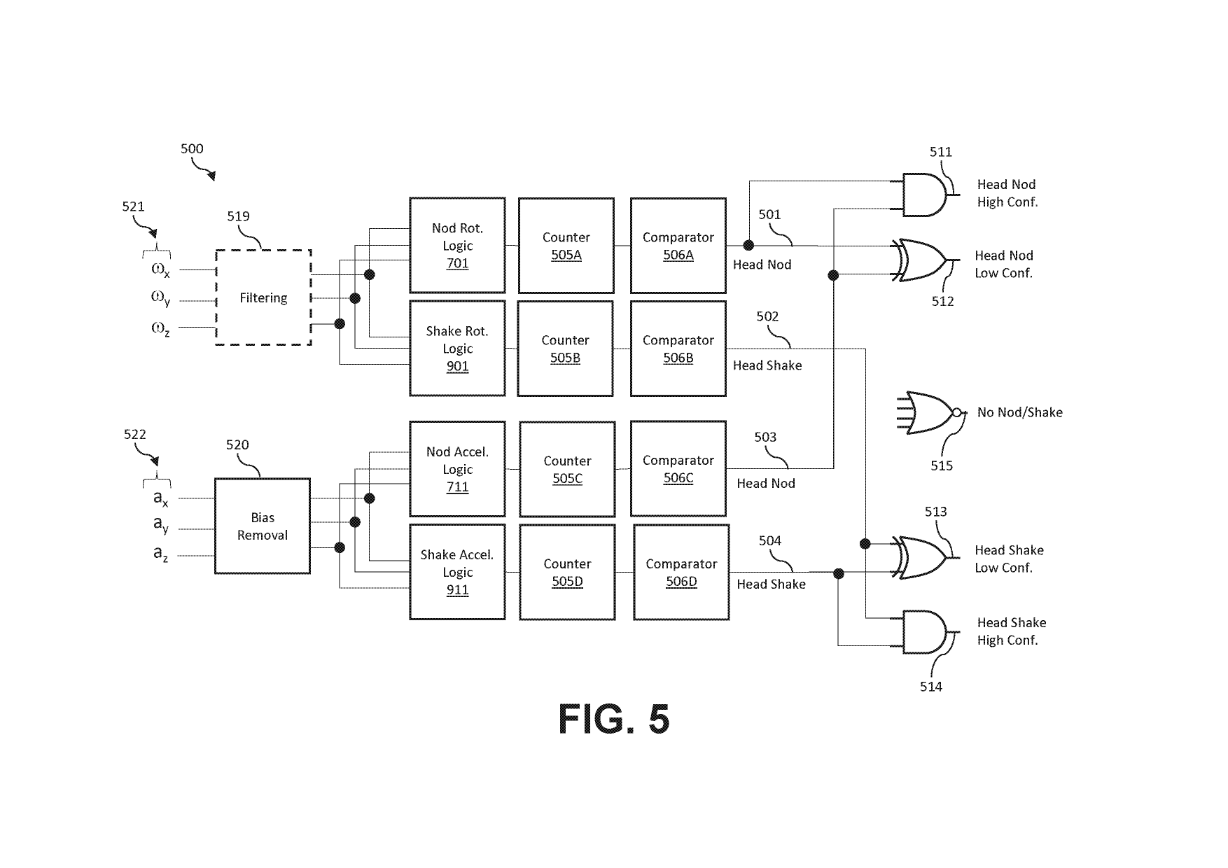

FIG. 5 is a block diagram of a gesture detector according to a possible implementation of the present disclosure. The figure illustrates how the gesture detector analyzes the measurements (i.e., data) from the IMU (e.g., gyroscope and accelerometer) to detect a head nod gesture (i.e., head nod) or a head shake gesture (i.e., head shake). This analysis may be carried out quickly and efficiently because it does not require (e.g., does not include) a machine learning model. The processing for the analysis can include filtering to improve the signals for the analysis and can further include the logic (i.e., rules) used to detect particular movements.

As shown, the gyroscope data 521 (ωₓ, ω_{y}, ω_{z}) can be received by a filtering block 519 of the gesture detector 500. This filtering block 519 may include low pass or band pass filtering, which can isolate head movements in the gyroscope data 521 from other movements, such as high-frequency vibrations, which are not typically associated with yes-no head-gesture movements.

The accelerometer data 522 (aₓ, a_{y}, a_{z}) can also be received by a bias removal block 520 of the gesture detector 500. This bias removal block 520 can remove the effects of gravity on the accelerometer data 522, which would otherwise cause one or more channels to be offset (i.e., biased) according to their direction with respect to gravity. In a possible implementation, the bias removal block 520 removes a bias from an acceleration measurement collected during the period by determining an initial value of the acceleration measurement at the start of the period and subtracting the initial value from the acceleration measurement collected during the period. In another possible implementation the bias removal block 520 computes an average value of the acceleration measurement for the period and subtracts the average value from the acceleration measurement collected during the period.

The gesture detector 500 can have a high level of parallelism. For example, it can simultaneously receive and process gyroscope data and accelerometer data. As shown, the processing for detection can include parallel paths, with the rules (i.e., logic) for each path being similar. The parallel paths may include movement logic configured to detect a movement (i.e., gesture). As shown, the movement logic of a first path includes nod rotation logic 701 configured to analyze the rotation measurements (ωₓ, ω_{y}, ω_{z}) collected by the plurality of gyroscopes during the period to detect a nod gesture. The movement logic of a second path can include shake rotation logic 901 configured to analyze the rotation measurements (ωₓ, ω_{y}, ω_{z}) collected by the plurality of gyroscopes during the period to detect a shake gesture. The movement logic of a third path can include nod acceleration logic 711 configured to analyze the acceleration measurements (aₓ, a_{y}, a_{z}) collected by the plurality of accelerometers during the period to detect a nod gesture. The movement logic of a fourth path can include shake acceleration logic 911 configured to analyze the acceleration measurements (aₓ, a_{y}, a_{z}) collected by the plurality of accelerometers during the period to detect a shake gesture.

Each path may include a counter (counter 505A, counter 505B, counter 505C, counter 505D) configured to count the number of times the head nod/shake is detected during the period. Each path may further include a comparator (comparator 506A, comparator 506B, comparator 506C, comparator 506D) configured to compare the number of times the shake or nod was detected during the period to a threshold (or thresholds). For example, a nod rotation gesture detected at least once (e.g., 1 to 3 times) may configure the comparator 506A of the first path to output a logical high signal, indicating a head nod. The thresholds at each comparator may be the same or different. For example, a threshold for detecting a head nod may be different than a threshold for detecting a head shake. In another example, a threshold for detecting a head nod based on rotation may be different than a threshold for detecting a head nod based on acceleration. based on the period. For a period of a few seconds (e.g., 3 seconds) the thresholds may any number in a range from one to five.

As shown, the gyroscope data 521 (ωₓ, ω_{y}, ω_{z}) can be analyzed for a nod and a shake in parallel paths (i.e., first and second paths). Likewise, accelerometer data 522 (aₓ, a_{y}, a_{z}) can be analyzed for a head nod and a head shake in parallel paths (i.e., third and fourth paths). As shown, the four outputs may each have a corresponding logical level according to its corresponding path of analysis. A first path output 501 can be a head nod detection based on the gyroscope data 521, a second path output 502 can be a head shake detection based on the gyroscope data 521, a third path output 503 can be a head nod detection based on the accelerometer data 522, and a fourth path output 504 can be a head shake detection based on the accelerometer data 522. If the rules (i.e., criteria) for detection of a path are satisfied, then the output for the path can be a logical high level (e.g., 1, TRUE, etc.), and if the rules (i.e. criteria) for detection for a path are not satisfied, then the path can output a logical low level (e.g., 0, FALSE, etc.).

In a possible implementation, a head nod/shake detection can be further characterized having a high confidence score (i.e., level) or a low confidence score (i.e., level). The high and low confidence levels may be relative to each other. A high confidence score associated with a detection (i.e., high confidence detection) may imply that the same detection was made by multiple types of motion sensors (e.g., accelerometers and gyroscopes), while a low confidence detection may imply that the detection was made by only one type of motion sensor. In other words, a high confidence detection may result from the detection being confirmed by multiple sensors. That is not to say, however, that a low confidence detection is not a valid detection. For example, in some conditions (e.g., low power) only one type of motion sensor is enabled, and the confirmation by multiple sensors is not possible. In this condition, only low confidence detections are possible, and these detections may be valid detections.

In some implementations, the four path outputs (i.e., four intermediate outputs) may be further analyzed to assign a confidence level to a detected head gesture. As shown, the analysis can include logical comparisons implemented, either in hardware or software, as logic gates (e.g., AND gate, XOR gate, NOR gate, etc.).

A first output 511 corresponds to a head nod detected with high confidence. An AND gate is coupled to the first output 511 so that when (i) a head nod is detected based on gyroscope data and (ii) a head nod is detected based on accelerometer data, the first output 511 is a logical high level (e.g., 1, TRUE).

A second output 512 corresponds to a head nod detected with low confidence. An exclusive-OR gate is coupled to the second output 512 so that when (i) a head nod is detected based on gyroscope data or (ii) a head nod is detected based on accelerometer data, but not both, the second output 512 is a logical high level (e.g., 1, TRUE).

A third output 513 corresponds to a head shake detected with low confidence. An exclusive-OR gate is coupled to the third output 513 so that when (i) a shake nod is detected based on gyroscope data or (ii) a head shake is detected based on accelerometer data, but not both, the third output 513 is a logical high level (e.g., 1, TRUE).

A fourth output 514 corresponds to a head shake detected with high confidence. An AND gate is coupled to the fourth output 514 so that when (i) a head shake is detected based on gyroscope data and (ii) a head shake is detected based on accelerometer data, the fourth output 514 is a logical high level (e.g., 1, TRUE).

By examining the four outputs of the gesture detector 500 at the end of a period, a head gesture and its confidence may be concluded. For example, if the second output 512 is TRUE while all other outputs are FALSE, then it can be concluded that a head nod was detected with a low confidence level during the period. If all outputs are FALSE, then it may be concluded that (i) there was no head nod detected during the period and (ii) there was no head shake detected during the period.

A fifth output 515 corresponds to no nod/shake. A NOR gate is coupled to the fifth output 515 so that when (i) a head shake is not detected based on gyroscope data; (ii) a head shake is not detected based on accelerometer data; (iii) a head nod is not detected based on gyroscope data; and (iv) a head nod is not detected based on accelerometer data, the fifth output 515 is a logical high level (e.g., 1, TRUE).

The gyroscope data may more accurately reflect the movements of a head nod or a head shake than the accelerometer, but the gyroscopes can consume more power than the accelerometers. Accordingly, a high-confidence detection, in which gyroscope detection is verified by an accelerometer detection, may consume too much power in some scenarios. For example, when the head-worn device is in a low-power mode (e.g., due to a low battery), the gyroscopes may be disabled, and the accelerometers may be used alone for a low-confidence detection.

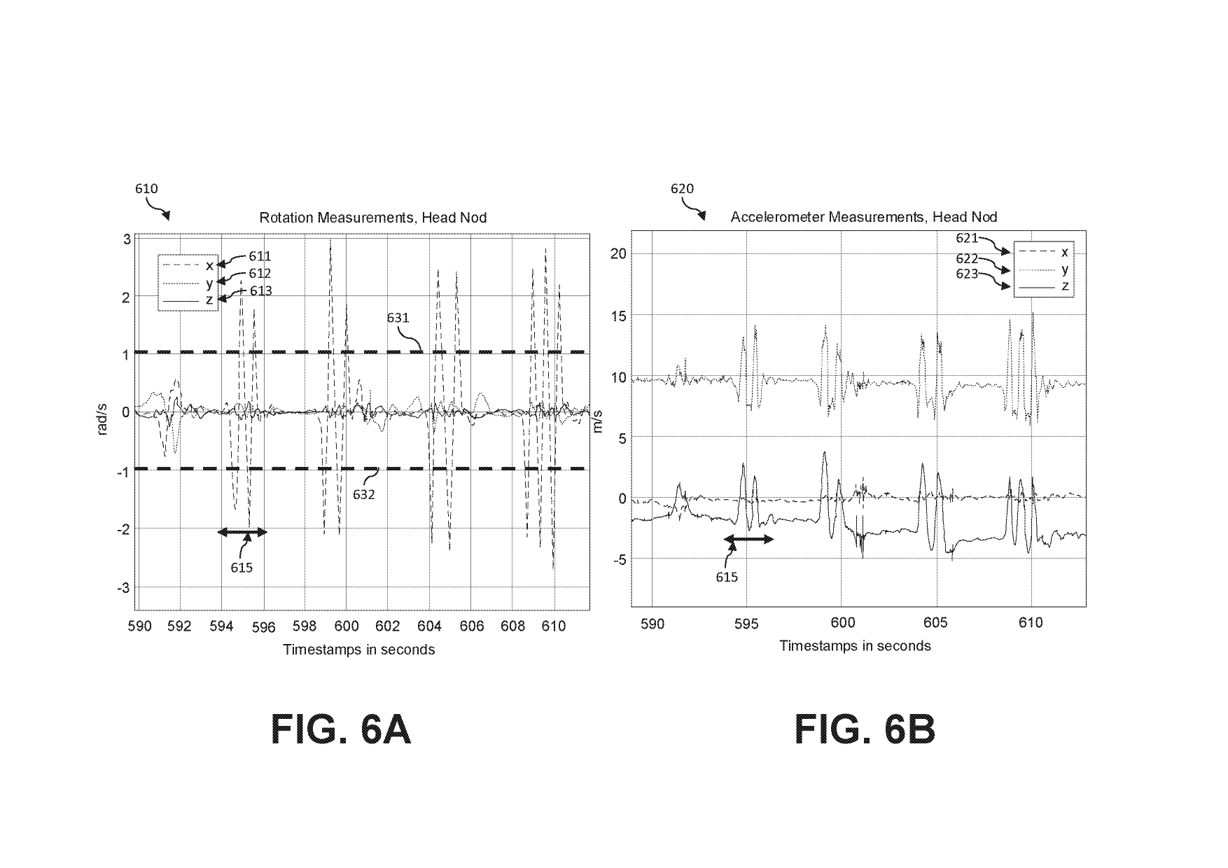

FIG. 6A illustrates rotation measurements corresponding to a head nod according to a possible implementation of the present disclosure. The graph 610 illustrates raw rotation data (ωₓ, ω_{y}, ω_{z}) captured by gyroscopes, which are positioned and oriented to measure a rotation around the X-axis 201, a rotation around the Y-axis 202, and a rotation around the Z-axis 203 of a head-worn device as shown in FIGS. 2A-2B. In particular, an X-axis rotation 611, a Y-axis rotation 612, and a Z-axis rotation 613 are shown. As discussed, a head nod 220 causes an X-axis rotation 611 to be larger than the other rotation measurements. As shown in FIG. 6A, four head nods are detected during a period 615. The period 615 is approximately 3 seconds long. Each head nod can be detected when (i) the X-axis rotation 611 has a positive amplitude that exceeds a positive threshold level 631 (e.g., +1 rad/sec) or (ii) the X-axis rotation 611 has a negative amplitude exceeds a negative threshold level 632 (e.g., -1 rad/sec). ). In a possible implementation, the magnitudes of the rotation measurements may be compared to a single threshold.

FIG. 6B illustrates acceleration measurements corresponding to a head nod according to a possible implementation of the present disclosure. The graph 620 illustrates raw acceleration data (aₓ, a_{y}, a_{z}) captured by accelerometers, which are positioned and oriented to measure an acceleration along the X-axis 201, an acceleration along Y-axis 202, and an acceleration along Z-axis 203 of a head-worn device as shown in FIGS. 2A-2B. In particular, an X-axis acceleration 621, a Y-axis acceleration 622, and a Z-axis acceleration 623 are shown. As discussed, a head nod 220 can cause the Y-axis acceleration 622 and the Z-axis acceleration 623 to be larger than the X-axis acceleration 621. In other words, a head nod can be detected when the Y-axis acceleration 622 and the Z-axis acceleration 623 exceed a threshold, and the X-axis acceleration 621 does not exceed the threshold.

Detecting head-nods may require removing a bias from each of the acceleration measurements so that their average values are approximately equal. As shown, a bias of about 10 m/s² can be observed on the Y-axis, which may correspond to a large component of gravity in this direction. With the bias removed, at least one head nod can be detected during the period 615. Accordingly, the data shown in FIG. 6A and 6B could correspond to a head nod detected with high confidence.

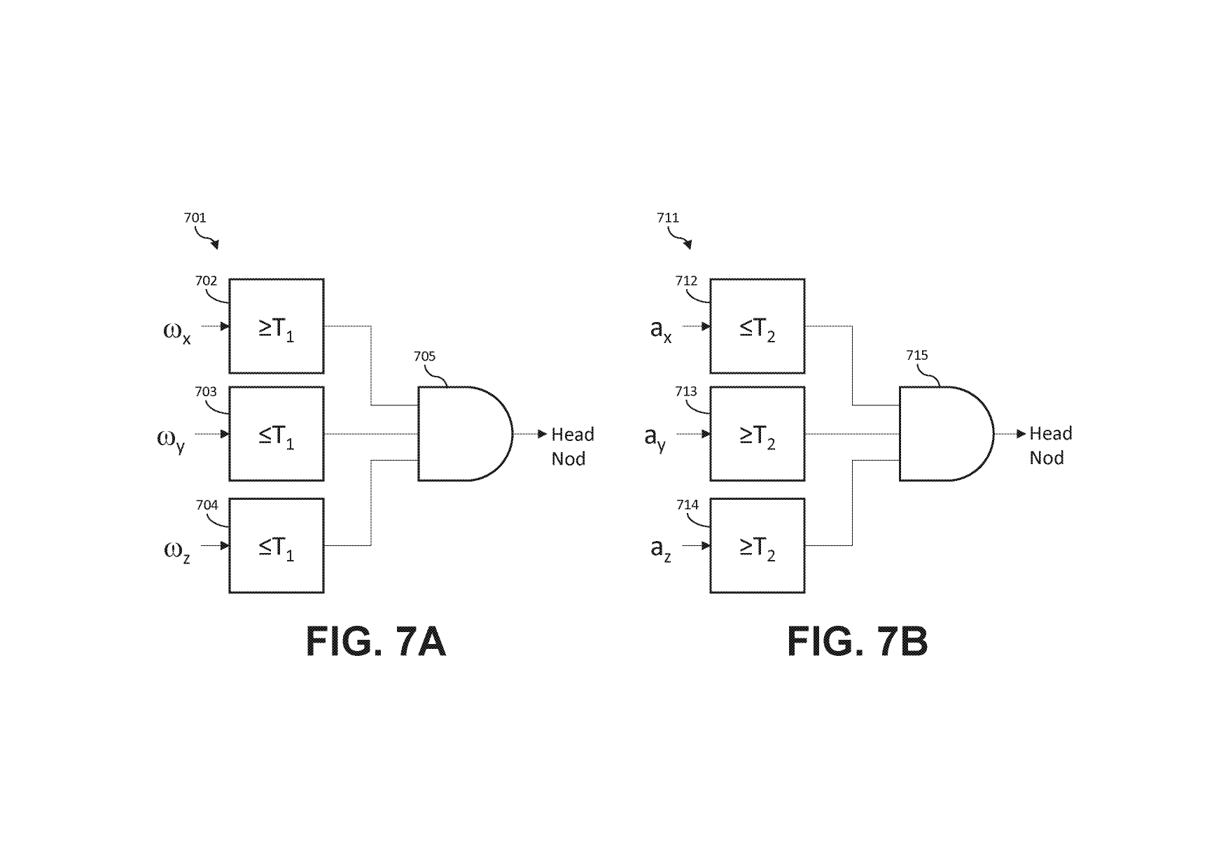

FIG. 7A illustrates nod rotation logic 701 according to a possible implementation of the present disclosure. As shown, the X-axis rotation may be compared to a first threshold (T₁) by a first comparator 702, the Y-axis rotation may be compared to the first threshold by a second comparator 703, and the Z-axis rotation may be compared to the first threshold by a third comparator 704. An AND gate 705 may output a detected head nod when (i) X-axis rotation exceeds (e.g., greater than or equal to) the first threshold (i.e., ωₓ ≥ T₁), (ii) the Y-axis rotation does not exceed the first threshold (i.e., ω_{y} ≤ T₁), and (iii) the Z-axis rotation does not exceed the first threshold (i.e., ω_{z} ≤ T₁). The nod rotation logic 701 may be implemented in hardware, software, or some combination thereof.

FIG. 7B illustrates nod acceleration logic 711 according to a possible implementation of the present disclosure. As shown, the X-axis acceleration may be compared to a second threshold (T₂) by a first comparator 712, the Y-axis acceleration may be compared to the second threshold by a second comparator 713, and the Z-axis acceleration may be compared to the second threshold by a third comparator 714. Prior to the comparisons a bias may be removed from the acceleration data. An AND gate 715 may output a detected head nod when (i) X-axis acceleration does not exceed the second threshold (i.e., aₓ ≤ T₂), (ii) the Y-axis acceleration exceeds the second threshold (i.e., a_{y} ≥ T₂), and (iii) the Z-axis rotation exceeds the second threshold (i.e., a_{z} ≥ T₁). The nod acceleration logic 711 may be implemented in hardware, software, or some combination thereof.

The processor of a head-worn device can be configured to transmit a yes-response as the response-reply signal when the head gesture detected is a head nod and the head nod has a high confidence level. The head nod can have the high confidence level when a first logical condition is TRUE at least one time during the period. The first logical condition can include each of the following being TRUE: the X-axis rotation of the head-worn device is above a first threshold; the Y-axis rotation of the head-worn device is below the first threshold; the Z-axis rotation of the head-worn device is below the first threshold; the X-axis acceleration of the head-worn device is below a second threshold; the Y-axis acceleration of the head-worn device is above the second threshold; and the Z-axis acceleration of the head-worn device is above the second threshold.

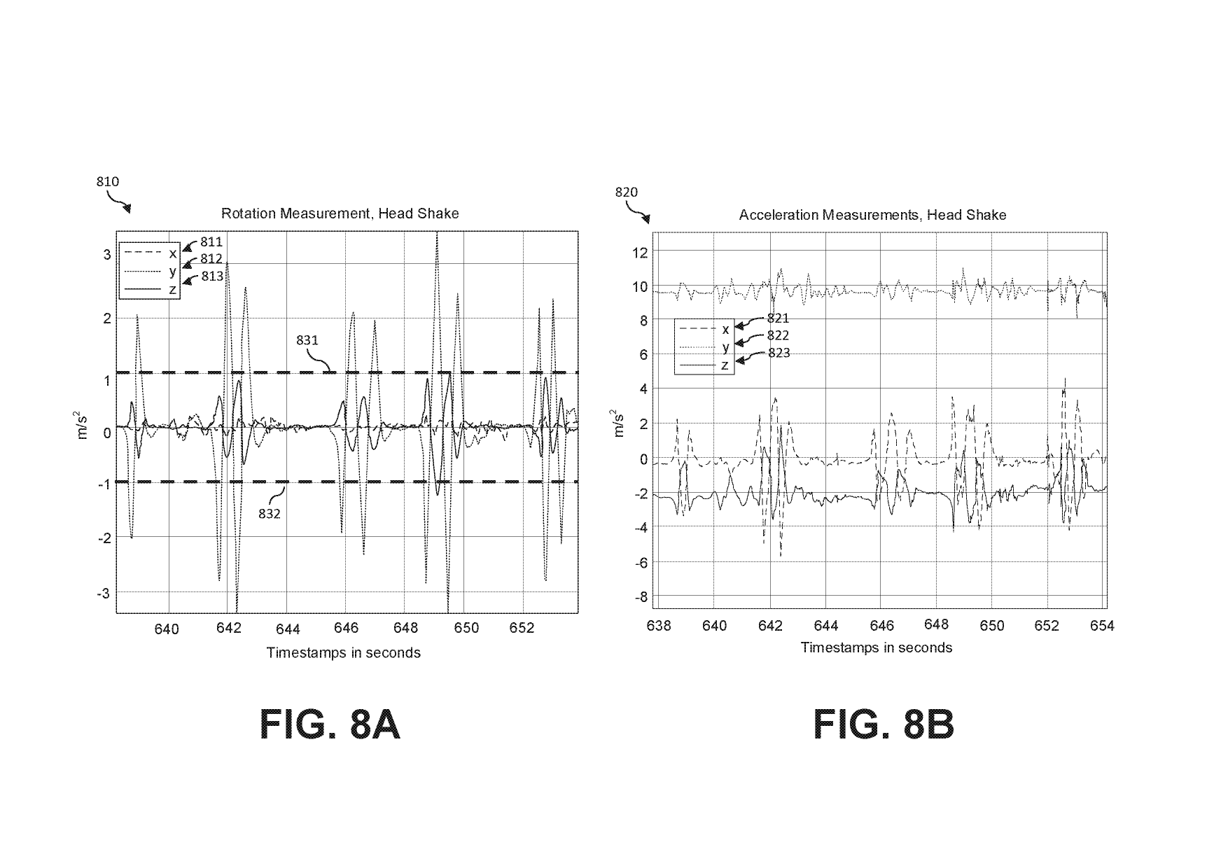

FIG. 8A illustrates rotation measurements corresponding to a head shake according to a possible implementation of the present disclosure. The graph 810 illustrates raw rotation data (ωₓ, ω_{y}, ω_{z}) captured by gyroscopes, which are positioned and oriented to measure a rotation around the X-axis 201, a rotation around the Y-axis 202, and a rotation around the Z-axis 203 of a head-worn device as shown in FIGS. 2A-2B. In particular, an X-axis rotation 811, a Y-axis rotation 812, and a Z-axis rotation 813 are shown. As discussed, a head shake 210 causes an Y-axis rotation 812 to be larger than the other rotation measurements. Each head shake movement can be detected when (i) the Y-axis rotation 812 has a positive amplitude that exceeds a positive threshold level 831 (e.g., +1 rad/sec) or (ii) the Y-axis rotation 812 has a negative amplitude exceeds a negative threshold level 832 (e.g., -1 rad/sec). In a possible implementation, the magnitudes of the rotation measurements may be compared to a single threshold.

FIG. 8B illustrates acceleration measurements corresponding to a head shake according to a possible implementation of the present disclosure. The graph 820 illustrates raw acceleration data (aₓ, a_{y}, a_{z}) captured by accelerometers, which are positioned and oriented to measure an acceleration along the X-axis 201, an acceleration along Y-axis 202, and an acceleration along Z-axis 203 of a head-worn device as shown in FIGS. 2A-2B. In particular, an X-axis acceleration 821, a Y-axis acceleration 822, and a Z-axis acceleration 823 are shown. As discussed, a head shake 210 can cause the X-axis acceleration 821 and the Z-axis acceleration 823 to be larger than the Y-axis acceleration 822. In other words, a head shake can be detected when the X-axis acceleration 821 and the Z-axis acceleration 823 exceed a threshold, and the Y-axis acceleration 822 does not exceed the threshold.

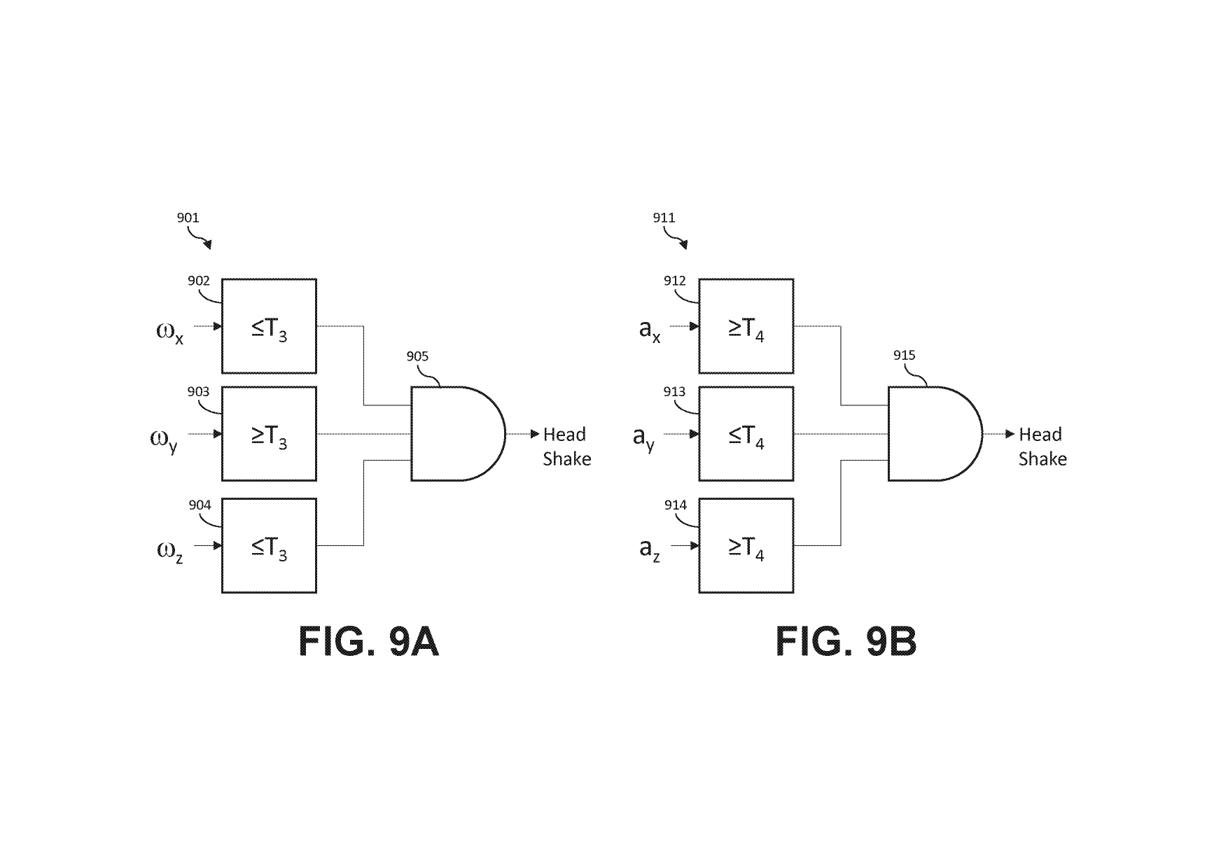

FIG. 9A illustrates shake rotation logic 901 according to a possible implementation of the present disclosure. As shown, the X-axis rotation may be compared to a third threshold (T₃) by a first comparator 902, the Y-axis rotation may be compared to the third threshold by a second comparator 903, and the Z-axis rotation may be compared to the third threshold by a third comparator 904. An AND gate 905 may output a detected shake when (i) X-axis rotation does not exceed the third threshold (i.e., ωₓ ≤ T₃), (ii) the Y-axis rotation exceeds the third threshold (i.e., ω_{y} ≥ T₃), and (iii) the Z-axis rotation does not exceed the first threshold (i.e., ω_{z} ≤ T₃). The shake rotation logic 901 may be implemented in hardware, software, or some combination thereof.

FIG. 9B illustrates shake acceleration logic 911 according to a possible implementation of the present disclosure. As shown, the X-axis acceleration may be compared to a fourth threshold (T₄) by a first comparator 912, the Y-axis acceleration may be compared to the fourth threshold by a second comparator 913, and the Z-axis acceleration may be compared to the fourth threshold by a third comparator 914. Prior to the comparisons a bias may be removed from the acceleration data. An AND gate 915 may output a detected head shake when (i) X-axis acceleration exceeds the fourth threshold (i.e., aₓ ≥ T₄), (ii) the Y-axis acceleration does not exceed the fourth threshold (i.e., a_{y} ≤ T₄), and (iii) the Z-axis rotation exceeds the fourth threshold (i.e., a_{z} ≥ T₄). The shake acceleration logic 911 may be implemented in hardware, software, or some combination thereof.

The processor of a head-worn device can be configured to transmit a no-response as the response-reply signal when the head gesture detected is a head shake and the head shake has a high confidence level. The head shake has the high confidence level when a second logical condition is TRUE at least one time during the period. The second logical condition can include the X-axis rotation of the head-worn device is below a first threshold; the Y-axis rotation of the head-worn device is above the first threshold; the Z-axis rotation of the head-worn device is below the first threshold; the X-axis acceleration of the head-worn device is above a second threshold; the Y-axis acceleration of the head-worn device is below the second threshold; and the Z-axis acceleration of the head-worn device is above the second threshold.

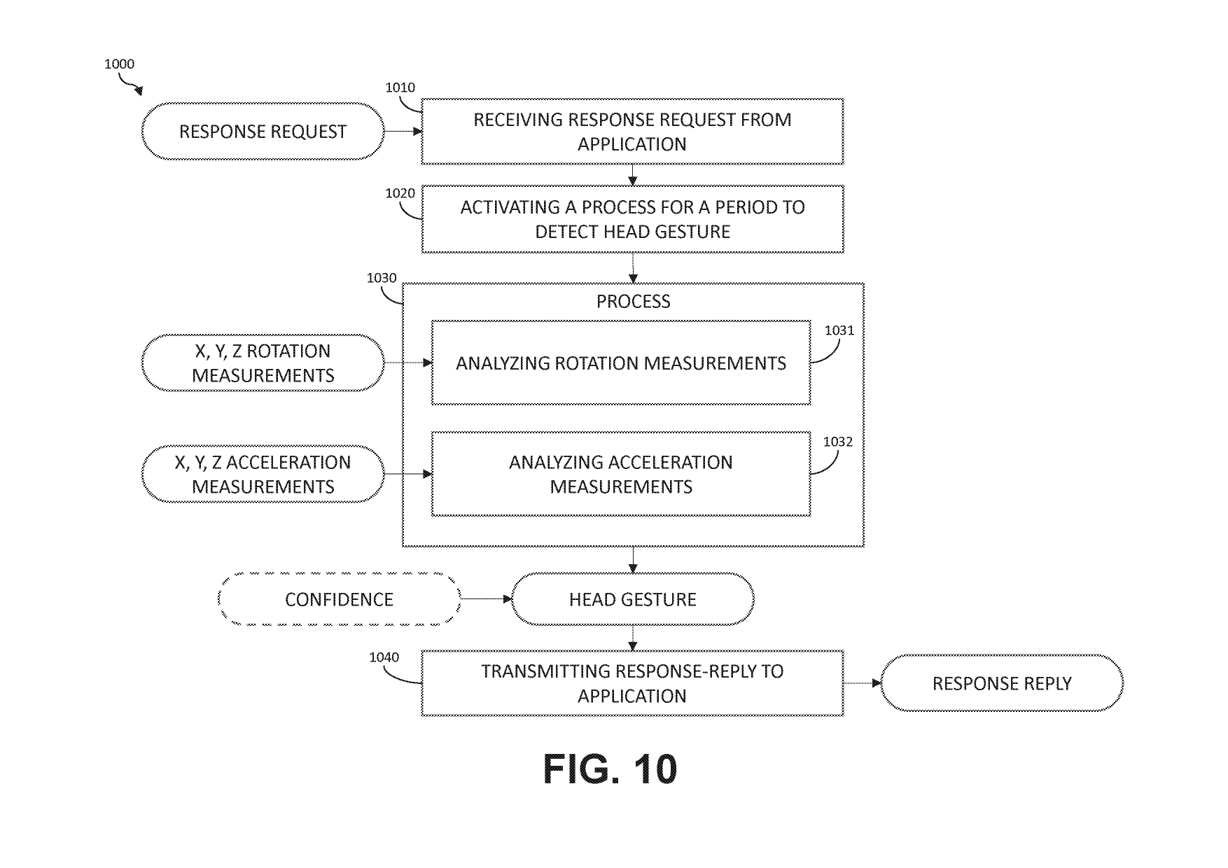

FIG. 10 is a flowchart of a method for interacting with an application based on a head gesture (e.g., nod or shake) according to a possible implementation of the present disclosure. The method 1000 includes the operation 1010 of receiving a response-request signal from an application. The response-request signal may correspond to a yes-no request (i.e., yes-no prompt) from the application. The application can be run on a processor of a head-worn device, which includes a plurality of motion sensors (e.g., gyroscopes and accelerometers). After the response-request signal is received, the method 1000 includes the operation 1020 of activating a process 1030 on the head-worn device for a period after the response-request signal. In other words, the process may continue until the period expires. The process 1030 can include analyzing 1031, using logic, the rotation measurements collected by the plurality of gyroscopes during the period to detect a head gesture (e.g., nod or shake) and analyzing 1032, using logic, the acceleration measurements collected by the plurality of accelerometers during the period to assign a confidence to the head gesture (e.g., high confidence, low confidence). The method 1000 further includes the operation 1040 of transmitting a response-reply signal (i.e., yes-response, no-response) to the application based on the head gesture and (optionally) the confidence after the period has ended (e.g., after an expiration of the period).

In a possible implementation of the method 1000, the response-reply signal is a yes-response when the head gesture is a head nod and the head nod has a high-confidence level.

In a possible implementation of the method 1000, the head gesture is the head nod when an X-axis rotation measurement is above a threshold, a Y-axis rotation measurement is below the first threshold; and a Z-axis rotation measurement is below the threshold.

In a possible implementation of the method 1000, the head nod has the high-confidence level when an X-axis acceleration measurement is below a second threshold; a Y-axis acceleration measurement is above the threshold, and a Z-axis acceleration of the head-worn device is above the threshold.

In a possible implementation of the method 1000, the response-reply signal is a no-response to the application when the head gesture is a head shake and the head shake has a high-confidence level.

In a possible implementation of the method 1000, the head gesture is the head shake when the X-axis rotation measurement is below a threshold, the Y-axis rotation measurement is above the threshold, and the Z-axis rotation measurement is below the threshold.

In a possible implementation of the method 1000, the head shake has a high-confidence level when the X-axis acceleration measurement is above a threshold, the Y-axis acceleration measurement is below the threshold; and the Z-axis acceleration measurement is above the threshold.

In a possible implementation, the method 1000 includes removing a bias from an acceleration measurement collected during a period. For example, the bias removal can include determining an initial value of the acceleration measurement at a start of a period, which can be between 1 and 3 seconds, and subtracting the initial value from the acceleration measurement collected during the period. In another example, the bias removal can include computing an average value of the acceleration measurement for the period, and subtracting the average value from the acceleration measurement collected during the period.

The process 1030 of analyzing the rotation measurements collected by the plurality of gyroscopes during a period to detect the head gesture and analyzing the acceleration measurements collected by the plurality of accelerometers during the period to assign the confidence to the head gesture does not include a machine learning model. As a result, the process may be carried out faster than one which includes a machine learning model, and the process may consume less power than one which includes a machine learning model.

In the specification and/or figures, typical embodiments have been disclosed. The present disclosure is not limited to such exemplary embodiments. For example, while the head shake 210 gesture and the head nod 220 gesture have been discussed at length due to their relationship with the NO and YES responses, other gestures can be conceived as suitable for detection using the rules-based approach. One possible other gesture that can be detected using simple logic (i.e., rules) instead of machine learning models is the head tilt.

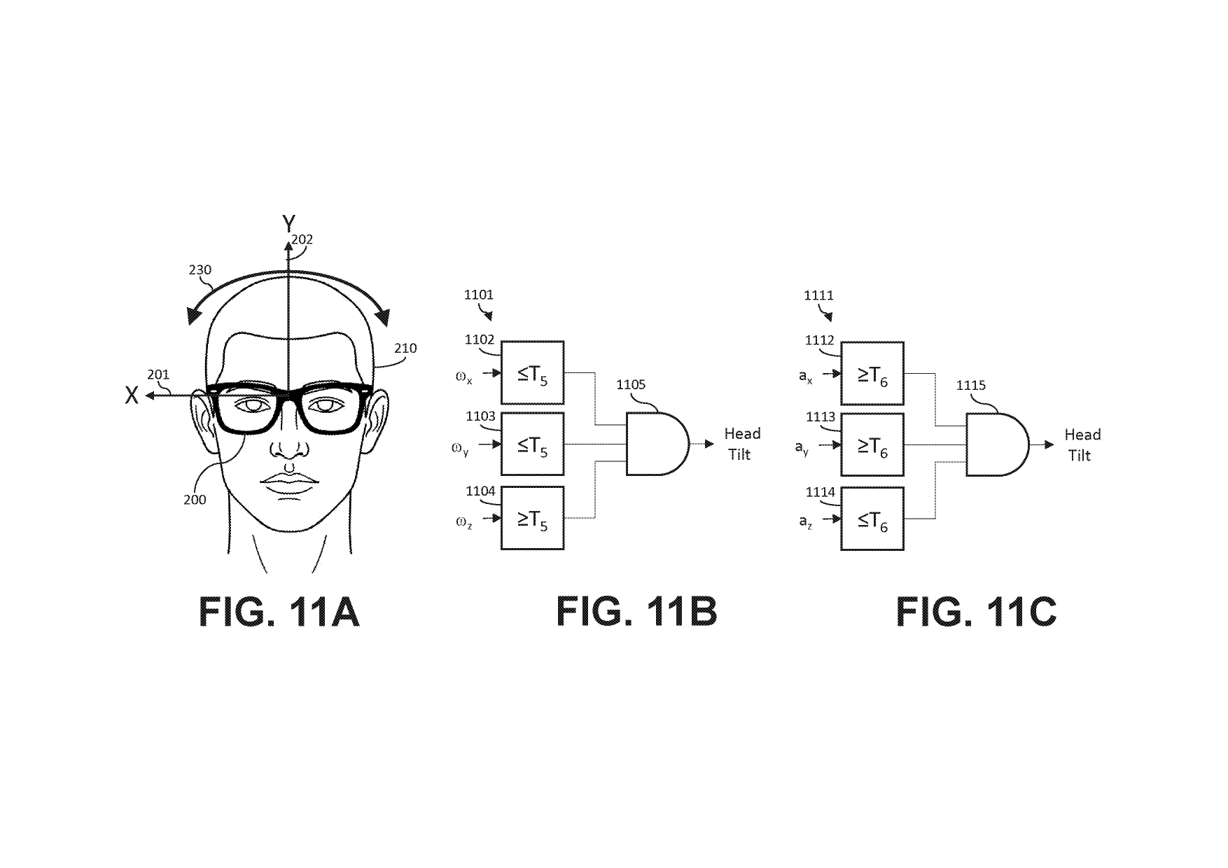

FIG. 11A illustrates a head tilt gesture of a user wearing a head-worn device according to a possible implementation of the present disclosure. As shown, the head 235 of the user wearing AR glasses 200 can be related to a coordinate system including an X-axis 201 and a Y-axis 202. A Z-axis (not shown) points into and out of the page. A head tilt 230 may include the user rotating their head 235 around the Z-axis so that the top of the user’s head moves alternatively right (i.e., +X direction) and left (i.e., -X direction), while the user’s face remains pointed as shown (i.e., -Z direction as shown in FIG. 2B).

In a possible implementation, the gesture detector 500 (see FIG. 5) can be further configured with a first additional path including rotation tilt rotation logic and a second additional path including tile acceleration logic. As with the other paths in the gesture detector 500, logic gates may be added to the outputs of the additional paths and used to detect a head tilt with high confidence and to detect a head tilt with low confidence.

FIG. 11B illustrates tilt rotation logic according to a possible implementation of the present disclosure. As shown, the X-axis rotation (ωₓ) may be compared to a fifth threshold (T₅) by a first comparator 1102, the Y-axis rotation (ω_{y}) may be compared to the fifth threshold by a second comparator 1103, and the Z-axis rotation (ω_{z}) may be compared to the fifth threshold by a third comparator 1104. An AND gate 1105 may output a detected head tilt when (i) X-axis rotation does not exceed the fifth threshold (i.e., ωₓ ≤ T₅), (ii) the Y-axis rotation does not exceed the third threshold (i.e., ω_{y} ≤ T₅), and (iii) the Z-axis rotation exceeds the first threshold (i.e., ω_{z} ≥ T₅). The tilt rotation logic 1101 may be implemented in hardware, software, or some combination thereof.

FIG. 11C illustrates tilt acceleration logic 1111 according to a possible implementation of the present disclosure. As shown, the X-axis acceleration may be compared to a sixth threshold (T₆) by a first comparator 1112, the Y-axis acceleration may be compared to the sixth threshold by a second comparator 1113, and the Z-axis acceleration may be compared to the sixth threshold by a third comparator 1114. Prior to the comparisons a bias may be removed from the acceleration data. An AND gate 1115 may output a detected head tilt when (i) X-axis acceleration exceeds the sixth threshold (i.e., aₓ ≥ T₄), (ii) the Y-axis acceleration exceeds the sixth threshold (i.e., a_{y} ≥ T₆), and (iii) the Z-axis rotation does not exceed the sixth threshold (i.e., a_{z} ≤ T₆). The tilt acceleration logic 1111 may be implemented in hardware, software, or some combination thereof.

The gestures described here include a first gesture (i.e., head shake 210) that is primarily a rotation of the head 235 around the Y-axis 202. A second gesture (i.e., head nod 220) that is primarily a rotation of the head 235 around the X-axis 201, and a third gesture (i.e., head tilt 230) that is primarily a rotation of the head 235 around the Z-axis 203. More complex movements may require more complicated detection schemes (e.g., machine learning models), which may be less desirable than the low complexity rules described here.

The thresholds in the logic (e.g., T₁, T₂, T₃, T₄, T₅, T₆) may be predetermined based on empirical data collected from a population of users to balance sensitivity and specificity. In other possible implementations, these thresholds may be user-adjustable or dynamically adapted by the system based on observed user behavior or environmental conditions. In another possible implementation all the rotation thresholds are equal (e.g., T₁ = T₃ = T₅), all the acceleration thresholds are equal (e.g., T₂ = T₄ = T₆), and the rotation thresholds do not equal the acceleration thresholds. In another possible implementation all of the thresholds are equal (e.g., T₁ = T₂ = T₃ = T₄ = T₅ = T₆).

In the specification, the use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from "about" one particular value, and/or to "about" another particular value. When such a range is expressed, an aspect includes from the one particular value and/or to the other particular value. Similarly, when values are expressed as approximations, by use of the antecedent "about," it will be understood that the particular value forms another aspect. It will be further understood that the endpoints of each of the ranges are significant both in relation to the other endpoint, and independently of the other endpoint.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

1. A method comprising:
receiving a response-request signal from an application running on a head-worn device, the head-worn device including a plurality of gyroscopes and a plurality of accelerometers; and
activating a process for a period initiated by the response-request signal, the process including:
analyzing, using logic, rotation measurements collected by the plurality of gyroscopes during the period to detect a head gesture;
analyzing, using logic, acceleration measurements collected by the plurality of accelerometers during the period to assign a confidence to the head gesture; and
transmitting a response-reply signal to the application based on the head gesture and the confidence.

2. The method according to claim 1, wherein the response-reply signal is a yes-response in response to determining:
the head gesture detected is a head nod; and
the head nod has a high-confidence level.

3. The method according to claim 2, wherein the head gesture detected is the head nod in response to determining:
an X-axis rotation of the head-worn device is at or above a first threshold;
a Y-axis rotation of the head-worn device is below the first threshold; and
a Z-axis rotation of the head-worn device is below the first threshold.

4. The method according to claim 3, wherein the head nod has the high-confidence level in response to determining:
an X-axis acceleration of the head-worn device is below a second threshold;
a Y-axis acceleration of the head-worn device is above the second threshold; and
a Z-axis acceleration of the head-worn device is above the second threshold.

5. The method according to claim 1, wherein the response-reply signal is a no-response in response to determining:
the head gesture detected is a head shake; and
the head shake has a high-confidence level.

6. The method according to claim 5, wherein the head gesture detected is the head shake in response to determining:
an X-axis rotation of the head-worn device is below a first threshold;
a Y-axis rotation of the head-worn device is above the first threshold; and
a Z-axis rotation of the head-worn device is below the first threshold.

7. The method according to claim 6, wherein the head shake has the high-confidence level in response to determining:
an X-axis acceleration is above a second threshold;
a Y-axis acceleration is below the second threshold; and
a Z-axis acceleration is above the second threshold.

8. The method according to claim 1, wherein analyzing the acceleration measurements includes:
removing a bias from an acceleration measurement collected during the period.

9. The method according to claim 8, wherein removing the bias from the acceleration measurement includes:
determining an initial value of the acceleration measurement at a start of the period; and
subtracting the initial value from the acceleration measurement collected during the period.

10. The method according to claim 8, wherein removing the bias from the acceleration measurement includes:
computing an average value of the acceleration measurement for the period; and
subtracting the average value from the acceleration measurement collected during the period.

11. The method according to claim 1, wherein the period is between 1 and 3 seconds.

12. The method according to claim 1, wherein analyzing the rotation measurements collected by the plurality of gyroscopes during the period to detect the head gesture, and analyzing the acceleration measurements collected by the plurality of accelerometers during the period to assign the confidence to the head gesture do not include a machine learning model.

13. A head-worn device comprising:
a plurality of gyroscopes configured to measure an X-axis rotation of the head-worn device, a Y-axis rotation of the head-worn device, and a Z-axis rotation of the head-worn device;
a plurality of accelerometers configured to measure an X-axis acceleration of the head-worn device, a Y-axis acceleration of the head-worn device, and a Z-axis acceleration of the head-worn device; and
a processor configured by software instructions activated by a response request signal received from an application running on the head-worn device to:
analyze, using logic, rotation measurements collected by the plurality of gyroscopes during a period to detect a head gesture;
analyze, using logic, acceleration measurements collected by the plurality of accelerometers during the period to assign a confidence to the head gesture; and
transmit a response-reply signal to the application in response to expiration of the period based on the head gesture and the confidence.

14. The head-worn device according to claim 13, wherein the response-reply signal is a yes-response in response to determining:
the head gesture detected is a head nod; and
the head nod has a high-confidence level.

15. The head-worn device according to claim 14, wherein the head nod has the high-confidence level in response to a first logical condition being TRUE at least one time during the period, the first logical condition being:
the X-axis rotation of the head-worn device is above a first threshold;
the Y-axis rotation of the head-worn device is below the first threshold;
the Z-axis rotation of the head-worn device is below the first threshold;
the X-axis acceleration of the head-worn device is below a second threshold;
the Y-axis acceleration of the head-worn device is above the second threshold; and
the Z-axis acceleration of the head-worn device is above the second threshold.

16. The head-worn device according to claim 13, wherein the response-reply signal is a no-response in response to determining:
the head gesture detected is a head shake; and
the head shake has a high-confidence level.

17. The head-worn device according to claim 16, wherein the head shake has the high-confidence level in response to a second logical condition being TRUE at least one time during the period, the second logical condition being:
the X-axis rotation of the head-worn device is below a first threshold;
the Y-axis rotation of the head-worn device is above the first threshold;
the Z-axis rotation of the head-worn device is below the first threshold;
the X-axis acceleration of the head-worn device is above a second threshold;
the Y-axis acceleration of the head-worn device is below the second threshold; and
the Z-axis acceleration of the head-worn device is above the second threshold.

18. The head-worn device according to claim 13, wherein to analyze the acceleration measurements, the processor is configured by the software instructions to:
remove a bias from an acceleration measurement collected during the period.

19. The head-worn device according to claim 18, wherein removing the bias from the acceleration measurement includes:
subtracting (i) an initial value from the acceleration measurement collected during the period or (ii) an average value of the acceleration measurement for the period from the acceleration measurement collected during the period.

20. A non-transitory computer-readable medium comprising software instructions stored thereon that when executed by a processor of a head-worn device cause the head-worn device to:
receive a response-request signal from an application running on the head-worn device, the head-worn device including a plurality of gyroscopes and a plurality of accelerometers; and
activate a process for a period initiated by the response-request signal, the process including:
analyzing, using logic, rotation measurements collected by the plurality of gyroscopes during the period to detect a head gesture;
analyzing, using logic, acceleration measurements collected by the plurality of accelerometers during the period to assign a confidence to the head gesture; and
transmitting a response-reply signal to the application based on the head gesture and the confidence.
